(19) United States
(12) Patent Application Publication
(10) Pub. No.: US 2014/0251549 A1
(43) Pub. Date: Sep. 11, 2014

(54) PEEL-OFF MODULE OF PRINTING DEVICE

(71) Applicant: TSC AUTO ID TECHNOLOGY CO., LTD., Taipei City (TW)

(72) Inventor: MING-CHUN HO, NEW TAIPEI CITY (TW)

(73) Assignee: TSC AUTO ID TECHNOLOGY CO., LTD., TAIPEI CITY (TW)

(21) Appl. No.: 13/785,293

(22) Filed: Mar. 5, 2013

(51) Int. Cl. B41J 29/00

(52) U.S. Cl. CPC B41J 29/00
USPC 156/759

(57) ABSTRACT

A peel-off module of a printing device is provided for peeling off consumables from a consumable tape. The peel-off module is located on a cover of the printing device and comprises at least a main body, a peeling bar, and a peeling roller module. The main body has at least two guiding slots. The peeling bar is connected to the main body for peeling off the consumables from the consumable tape. The peeling roller module is movably assembled to the at least two guiding slots. When an user wants to use the printing device, the peeling roller module is pushed along the at least two guiding slots to a first stop point of the at least two guiding slots and then is pressed down to a second stop point on one of the at least two guiding slots to have the peeling roller module steadily clamping the consumable tape.

### FIELD OF THE INVENTION

The present invention relates to a peel-off module of a printing device, and more particularly relates to a peel-off module assembled on the rolling cover of the printing device and the peeling roller module thereof is capable to move to an anchor point for steadily clamping the consumable tape.

### BACKGROUND OF THE INVENTION

Attending with the development and progression of technology, a great amount of business machines, such as copiers, barcode printers, printers, and scanners have been adopted in our daily life. Among the various business machines, the barcode printer is broadly used in business transaction for printing out the barcode stickers. The barcode stickers are widely used to on the external packing of the products for the purposes of delivering product information, product recognition, and showing price tag. For example, external packing of the well known digital versatile disc (DVD), drink, compact disc (CD), and other living goods are labeled by the barcode stickers to show the above mentioned information.

In present, printing and feeding the barcode stickers needs the usage of barcode printers. The barcode printers are provided with paper peeling function for peeling the barcode sticker off from the barcode tape along the feeding path and providing the barcode sticker to the users. However, most of the peel-off modules in the present barcode printers with paper peeling function are not located on the cover of the barcode printers. Such peel-off module occupies a significant space and brings challenges for minimizing the portable barcode printer. In addition, because the peel-off module needs to clamp the barcode tape firmly when operating, thus, after the barcode tape is loaded into the barcode printer, the user usually needs to perform some complicated operating processes to the peel-off module for have the peel-off module firmly clamping the barcode tape. For example, the user needs to push the peeling bar and the peeling roller of the peel-off module away from their original position before positioning the barcode tape into the barcode printer, and after the cover is closed, the user needs to push the peeling bar and the peeling roller back to their original position to fix the barcode tape.

### BRIEF SUMMARY OF INVENTION

The technical problem to be resolved and the object of the present invention:

In view of prior art, a significant space in the barcode printer is occupied by the peel-off module and the operating processes thereof is too complicated, thus, it is demanded to improve the conventional barcode printers.

Accordingly, it is a main object of the present invention to provide a peel-off module of a printing device, which is assembled on the cover of the printing device and the peeling roller module thereof is capable to firmly clamp the consumable tape by the simple operating process of pushing and pressing down. Thereby, the occupied space of the peel-off module can be reduced and the operating process is simplified.

The technical feature of the present invention for solving the problem:

In order to resolve the problems of prior art, a peel-off module of a printing device is provided in the present invention for peeling off a plurality of consumables from a consumable tape. The peel-off module is located on a cover of the printing device, and the peel-off module of the printing device comprises at least a main body, a peeling bar, and a peeling roller module. The main body has at least two guiding slots. The peeling bar is connected to the main body for peeling the consumables off from the consumable tape. The peeling roller module is movably assembled to the at least two guiding slots, such that when an user wants to use the printing device, the user can have the peeling roller module firmly clamping the consumable tape by pushing the peeling roller module along the at least two guiding slots to a first stop point on the at least two guiding slots and then pressing the peeling roller module down to a second stop point on one of the at least two guiding slots.

As a preferred embodiment, the printing device may be a barcode printer, the consumable tape may be a barcode tape, and the consumables may be barcode stickers. In addition, the peel-off module may have an entrance located between the peeling roller module and the peeling bar for feeding the consumable tape and have an exit between the peeling roller module and the main body for bringing out the consumable tape such that when the printing device is operating, the consumable tape enters the entrance, the peeling bar peels the consumables off simultaneously, and the consumable tape leaves the exit. Moreover, the peel-off module may further comprise a printing roller, which is connected to the main body. The printing roller and the peeling roller module are utilized for transferring the consumable tape to enter the entrance and leave the exit. In addition, the peeling roller module may further comprise a peeling roller and a peeling roller cover. The printing roller and the peeling roller are utilized for transferring the consumable tape to enter the entrance and leave the exit. The peeling roller cover is connected to the peeling roller for the user to drive the peeling roller module.

As a preferred embodiment of the present invention, the peeling roller module may further comprise at least two sliding portions. The at least two sliding portions are located on the peeling roller cover, and the peeling roller module moves along the guiding slots to the first stop point on the guiding slots and moves along the guiding slots to the second stop point on the one of the at least two guiding slots by using the sliding portions. In addition, the main body may have at least a first stop portion and at least a second stop portion thereon. The moving peeling roller module engages with the first stop portion to stop at the first stop point and engages with the second stop portion to stop at the second stop point.

The improvement of the present invention in compared with the prior art:

In contrast with the prior art, the peel-off module of the printing device provided in the present invention is assembled on the cover of the printing device, and thus the occupied space of the peel-off module is reduced to make minimization of the portable barcode printer easier. In addition, because the user only needs to perform two simple operating steps of pushing and pressing down to have the peeling roller module firmly clamping the consumable tape, thus, the operating process is enormously simplified to make the operating process convenient for the user.

The embodiments adopted in the present invention would be further discussed by using the flowing paragraph and the figures for a better understanding.

### BRIEF DESCRIPTION OF THE DRAWINGS

FIG. 1 is a schematic view showing a printing device with a peel-off module in accordance with a preferred embodiment of the present invention.

FIG. 2 is a schematic view showing a peel-off module in accordance with a preferred embodiment of the present invention from a first viewing angle.

FIG. 3 is a schematic view showing a peel-off module in accordance with a preferred embodiment of the present invention from a second viewing angle.

FIG. 4 is a schematic view showing a peel-off module in accordance with a preferred embodiment of the present invention from a third viewing angle.

FIG. 5 is a schematic view showing a peel-off module in accordance with a preferred embodiment of the present invention from a fourth viewing angle.

FIGS. 6, 6A, and 6B are cross-section views showing a peel-off module in accordance with a preferred embodiment of the present invention.

### DETAILED DESCRIPTION OF THE INVENTION

There are various embodiments of the peel-off module of the printing device in accordance with the present invention, which are not repeated hereby. The preferred embodiment is mentioned in the following paragraph as an example. It should be understood by those skilled in the art that the preferred embodiments disclosed in the following paragraph are merely an example instead of restricting the scope of the invention itself.

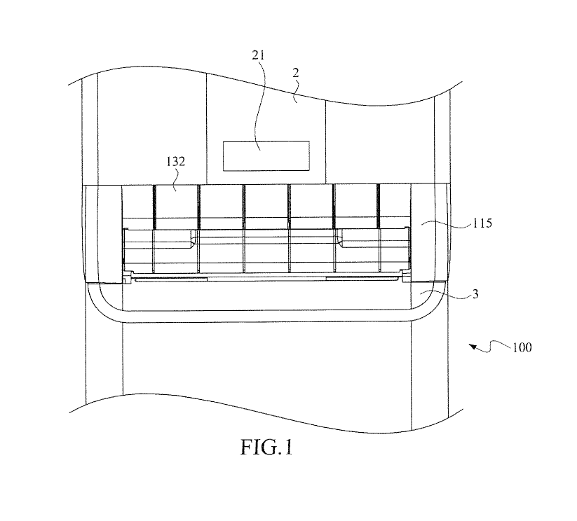

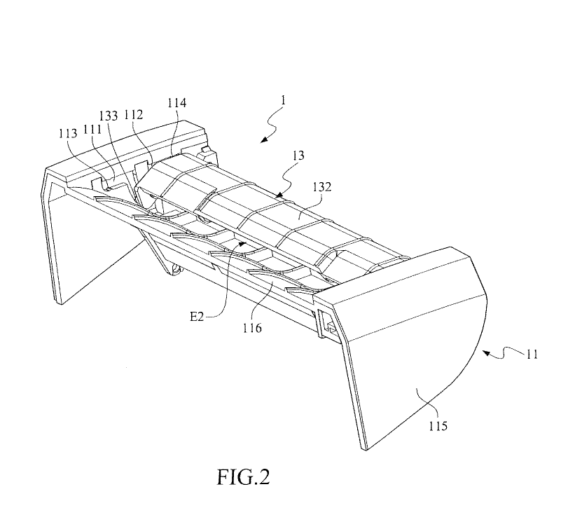

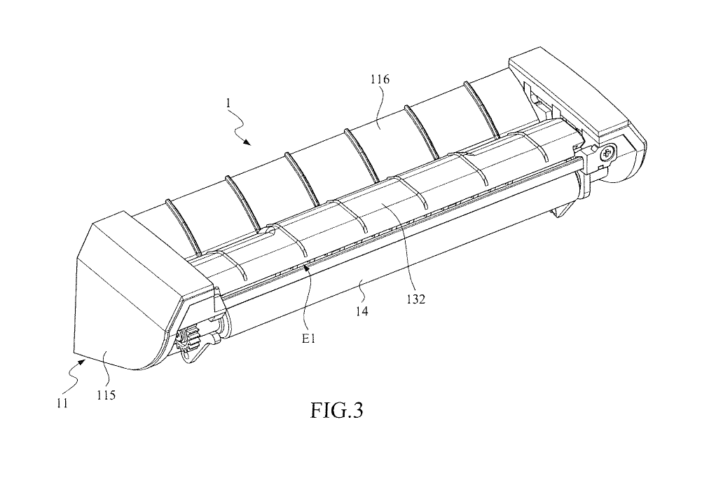

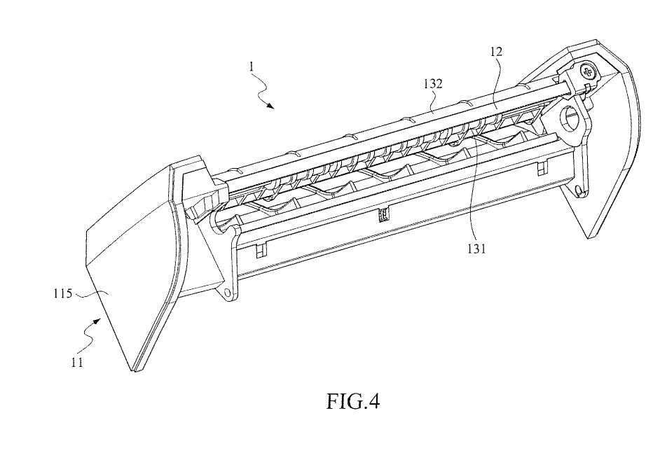

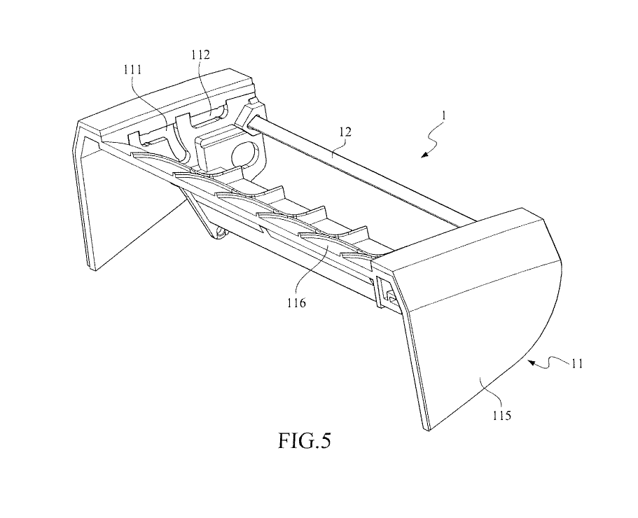

Please refer to FIGS. 1 to 5, wherein FIG. 1 is a schematic view showing a printing device with a peel-off module in accordance with a preferred embodiment of the present invention, FIG. 2 is a schematic view showing a peel-off module in accordance with a preferred embodiment of the present invention from a first viewing angle, FIG. 3 is a schematic view showing a peel-off module in accordance with a preferred embodiment of the present invention from a second viewing angle, FIG. 4 is a schematic view showing a peel-off module in accordance with a preferred embodiment of the present invention from a third viewing angle, and FIG. 5 is a schematic view showing a peel-off module in accordance with a preferred embodiment of the present invention from a fourth viewing angle.

As shown, the peel-off module 1 of the printing device 100 is assembled on a cover 3 of the printing device 100 for peeling off a plurality of consumables 21 from a consumable tape 2. As a preferred embodiment of the present invention, the printing device 100 is a barcode printer, the consumable tape 2 is a barcode tape, and the consumables 21 are the barcode stickers. However, the present invention is not so restricted. The peel-off module 1 includes a main body 11, a peeling bar 12, a peeling roller module 13, and a printing roller 14.

The main body 11 has two first guiding slots 111 (only one is shown in the figure) and two second guiding slots 112 (only one is shown in the figure), and the first guiding slot 111 is separated from the second guiding slot 112. As a preferred embodiment of the present invention, the main body 11 includes two connecting arms 115 and one connecting body 116. The connecting body 116 is located between the two connecting arms 115 and connected to the two connecting arms 115. In addition, the first guiding slots 111 and the second guiding slots 112 are located on the two connecting arms 115, and there have two first guiding slots 111 and two second guiding slots 112 corresponded to the two connecting arms 115. Moreover, the main body 11 also has three first stop portions 113, 113a, and 113b (only one is labeled in the figure) and two second stop portions 114 (only one is shown in this figure) located thereon. In detailed, the first stop portions 113 and 113a are located at the left end of the first guiding slot 111, and the first stop portion 113b is located at the lower end of the first guiding slot 111, the second stop portions 114 are located at the right end of the second slot 112.

The peeling bar 12 is connected to the main body 11, i.e. located between and connected to the two connecting arms 115. The peeling bar 12 may be fabricated by using the material of plastic, metal, or other high stiffness materials to enhance endurance. In the present embodiment, the peeling bar is made of metal and has a shape of triangle with sharp angles to enhance reliability of the peel-off operation.

An entrance E1 is located between the peeling roller module 13 and the peeling bar 12 for feeding the consumable tape 2 and an exit E2 is located between the peeling roller module 13 and the main body 11 for bringing out the consumable tape. In detailed, the exit E2 is located between the peeling roller module 13 and the connecting body 116. In addition, the peeling roller module 13 is movably assembled to the first guiding slots 111 and the second guiding slots 112.

The peeling roller module 13 includes a peeling roller 131, a peeling roller cover 132, two first sliding portions 133 and two second sliding portions 134. The peeling roller cover 132 is connected to the peeling roller 131. The first sliding portions 133 and the second sliding portions 134 are located on and connected to the peeling roller cover 132. The two first sliding portions 133 are movably assembled in the two first guiding slots 111, the two second sliding portions 134 are movably assembled in the two second guiding slots 112. A printing roller 14 is connected to the main body 11.

As the user starts up the printing device 100, the peeling bar 12 peels the consumables 21 off from the consumable tape 2. How to peeling the consumables 21 is a well known technology and thus is not repeated here. Meanwhile, the peeling roller module 13 and the printing roller 14 drive the consumable tape 2 to enter the entrance E1 and leave the exit E2. In detailed, the peeling roller 132 of the peeling roller module 13 and the printing roller 14 drive the consumable tape 2 to have the consumable tape 2 enter the entrance E1 and leave the exit E2. Thus, when the printing device is operating, the consumable tape 2 is fed from the entrance E1, the consumables 21 are peeled off from the consumable tape 2 by the peeling bar 21 simultaneously, and the consumable tape 2 further leaves the exit E2 for recovery.

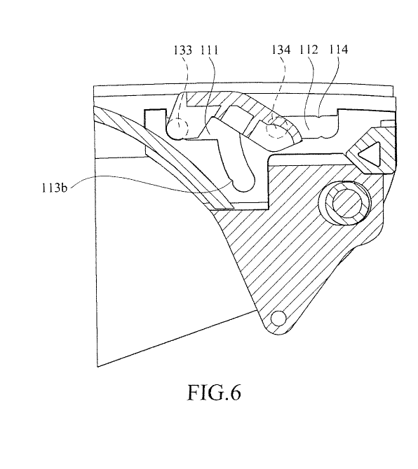

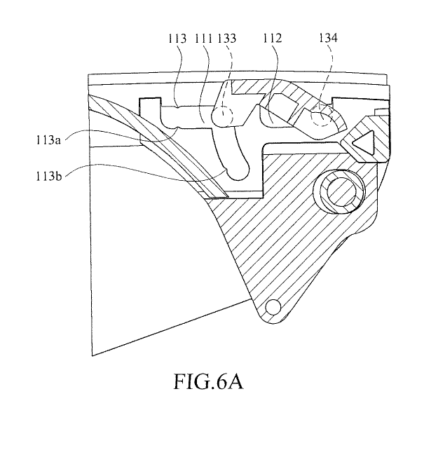

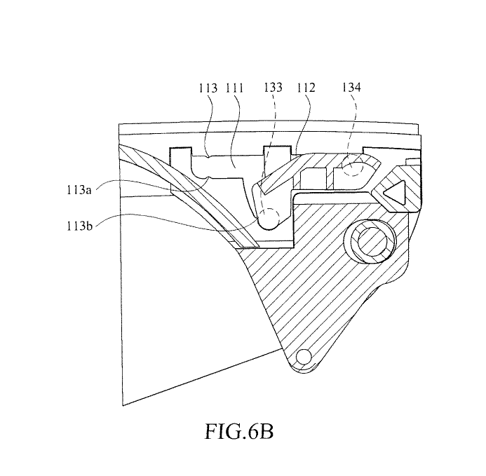

To describe the operating process of the peel-off module of the present invention in detail, please refer to FIGS. 1, 6, 6A, and 6B, wherein FIGS. 6, 6A, and 6B are the schematic cross-section views of the peel-off module in accordance with a preferred embodiment of the present invention. As shown in FIG. 1, in the beginning, the user opens the cover 3 of the printing device 100 and places the consumable tape 2. Afterward, a portion of the consumable tape 2 is pulled out from the printing device 100 and then the cover 3 is closed. Thereafter, the pulled-out portion of the consumable tape 2 is inserted into the entrance E1 and the exit E2. At this time, as shown in FIG. 6, the first sliding portion 133 is engaged with the first stop portions 113 and 113a.

Then, in order to have the peeling roller module 13 steadily clamping the consumable tape 2, the user pushes the peeling roller cover 132 to have the first sliding portions 133 and the second sliding portions 134 moving along the first guiding slots 111 and the second guiding slots 112 to the first stop points (not shown in this figure) defined on the first guiding slots 111 and the second guiding slots 112 respectively, as shown in FIG. 6A. At this time, the second sliding portion 134 is engaged with the second stop portion 114.

Then, the user presses the peeling roller cover 132 down to have the first sliding portion 133 moves along the first sliding slot 111 to a second stop point (not shown in this figure) defined on the first guiding slot 111, as shown in FIG. 6B. At this time, the first sliding portion 133 is engaged with the first stop portion 113b to have the peeling roller module 13 steadily clamping the consumable tape 2. The first stop point and the second stop point described in the preferred embodiment of the present invention are the positions the first sliding portion 133 and the second sliding portion 134 stop with respective to the two operating steps.

In conclusion, by using the peel-off module 1 of the printing device 100 provided in the present invention, the space demanded for locating the peel-off module 1 can be reduced by assembling the peel-off module 1 on the cover 3 of the printing device 100. Especially when the present invention is applied to the portable barcode printer, such design may make it easier to minimize the portable barcode printer. In addition, because only two operating steps of pushing and pressing are needed to have the peeling roller module 13 steadily clamping the consumable tape 2, thus, the operating process is enormously simplified to make the operating process quite convenient for the users.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

What is claimed is:

1. A peel-off module of a printing device, utilized for peeling off a plurality of consumables from a consumable tape and being located on a cover of the printing device, the peel-off module of the printing device comprising:
at least a main body, with at least two guiding slots;
a peeling bar, connected to the main body for peeling off the consumables from the consumable tape; and
a peeling roller module, movably assembled to the at least two guiding slots; wherein when an user wants to use the printing device, the user pushes the peeling roller module along the at least two guiding slots to a first stop point on the at least two guiding slots and then presses down the peeling roller module to a second stop point on one of the at least two guiding slots to have the peeling roller module steadily clamping the consumable tape.

2. The peel-off module of the printing device of claim 1, wherein the printing device is a barcode printer.

3. The peel-off module of the printing device of claim 1, wherein the consumable tape is a barcode tape and the consumables are barcode stickers.

4. The peel-off module of the printing device of claim 1, wherein the peel-off module has an entrance located between the peeling roller module and the peeling bar for feeding the consumable tape and has an exit located between the peeling roller module and the main body for bringing out the consumable tape, such that when the printing device is operating, the consumable tape enters the entrance, the peeling bar peels the consumables off from the consumable tape simultaneously, and the consumable tape leaves the exit.

5. The peel-off module of the printing device of claim 4, further comprising a printing roller, connected to the main body, and the printing roller and the peeling roller module being utilized for transferring the consumable tape to enter the entrance and leave the exit.

6. The peel-off module of the printing device of claim 5, wherein the peeling roller module further comprises a peeling roller, and the printing roller and the peeling roller are utilized for transferring the consumable tape to enter the entrance and leave the exit.

7. The peel-off module of the printing device of claim 6, wherein the peeling roller module further comprises a peeling roller cover, connected to the peeling roller for the user to drive the peeling roller module.

8. The peel-off module of the printing device of claim 7, wherein the peeling roller module further comprises at least two sliding portions, the at least two sliding portions are located on the peeling roller cover, and the peeling roller module moves along the at least two guiding slots by using the at least two sliding portions to the first stop point of the at least two guiding slots and moves along the at least two guiding slots to the second stop point on the one of the at least two guiding slots.

9. The peel-off module of the printing device of claim 1, wherein the main body has at least a first stop portion and at least a second stop portion thereon, the moving peeling roller module engages with the first stop portion to stop at the first stop point and engages with the second stop portion to stop at the second stop point.
